(19) United States
(12) Patent Application Publication
(10) Pub. No.: US 2013/0174191 A1
(43) Pub. Date: Jul. 4, 2013

(54) SYSTEMS AND METHODS FOR INCENTIVIZING USER INTERACTION WITH PROMOTIONAL CONTENT ON A SECONDARY DEVICE

(71) Applicants: Robert Barr Thompson, JR., Broomall, PA (US); Yulei Zhang, Shanghai (CN)

(72) Inventors: Robert Barr Thompson, JR., Broomall, PA (US); Yulei Zhang, Shanghai (CN)

(73) Assignee: UNITED VIDEO PROPERTIES, INC., Santa Clara, CA (US)

(21) Appl. No.: 13/339,914

(22) Filed: Dec. 29, 2011

(51) Int. Cl. H04N 7/16; G06F 3/02; G09G 5/00

(52) U.S. Cl. 725/23; 345/156; 345/168

(57) ABSTRACT

Systems and methods for incentivizing user interaction with promotional content on a secondary device are provided. The secondary device may be synchronized with the media content displayed on a primary device to provide promotional opportunities relevant to the displayed content. A promotional opportunity may allow a user to identify an object (which may be a product placement) embedded within the primary media content. For instance, the user may be prompted to select the object using a display screen on the secondary device. Alternatively, the user may use the secondary device to capture a photograph of the embedded object as displayed on the primary device. The user may then be rewarded for correctly identifying or photographing the embedded object.

### BACKGROUND OF THE INVENTION

Modern day consumers are confronted with numerous entertainment options and a large amount of available media content. Thousands of videos, songs, and articles are available to users through the Internet, television, and other gateways to media content. In such an environment, where user attention is at a premium and consumption options are plentiful, immersive and engaging promotional campaigns have taken on increasing importance.

In traditional systems, especially in the television or Internet streaming context, promotional campaigns are normally disruptive, unidirectional and advertisement-centric. For example, when a user is watching a television show over a cable system or Internet streaming service, commercials frequently interrupt the show with non-interactive advertisement content or content that does not require user interaction. Such commercial-based promotional schemes frustrate users and limit the utility of the advertisements. Moreover, these schemes narrow the amount of useful information advertisers may receive about the effectiveness of their commercials, since it's difficult to gauge a user's interest in an advertisement that can be consumed passively. New techniques for engaging users in promotional campaigns while simultaneously enhancing the overall media consumption experience are therefore highly desirable.

### SUMMARY OF THE INVENTION

Accordingly, systems and methods for incentivizing user interaction with promotional content on a secondary device are provided. The secondary device (e.g., a phone or tablet computer) may be synchronized with the media content displayed on a primary device (e.g., a television or Internet streaming device) to provide promotional opportunities relevant to the displayed content. The phrase “media content displayed on a primary device” is also referred to herein as “primary media content.” In some embodiments, the secondary device may allow a user to identify an object embedded within the primary media content.

For example, the user may select the embedded object from a display screen on the secondary device that presents (a) another instance or copy of the primary media content, (b) a screenshot of a particular scene of the primary media content, or (c) a set of objects provided as part of a game. The secondary device may have a touch-sensitive screen and the object selection may be indicated via user actuation of the touchsensitive display screen at the location of the object. As another example, the user may use the secondary device to capture a photograph of the embedded object as displayed on the primary device, or to capture a photograph of a product similar to the embedded object. The photograph may be provided to a remote server for analysis and confirmation that it depicts the embedded object.

In some embodiments, the user identification of the embedded object is used to reward the user. For instance, the user may receive points redeemable for real products or consumption benefits, such as commercial-free viewing, higher quality streaming, or free access to otherwise pay programming. Thus, the user has an incentive to participate in the promotional opportunity provided on the secondary device. Moreover, since the promotional opportunity is provided on the secondary device, it does not disrupt viewing activity on the primary device. Finally, advertisers are provided with a way to reinforce the promotional effect of product placements in media content, while also deriving useful information on the effectiveness of the product placements and promotional opportunities.

In an exemplary embodiment, a data record identifying media content displayed on a primary device may be received, e.g., by a remote server or the secondary device. The server or device may then query a database, based on the data record, for promotional data associated with the identified media content, wherein the promotional data defines a promotional opportunity to identify an object corresponding to a product placement. The promotional data may be provided to the secondary device, where the promotional opportunity is displayed to the user. A user indication may be received (i.e., through an interface provided by the secondary device) corresponding to an attempt to identify the object displayed on the primary device. In response to the user indication, the server may analyze the user indication to determine whether the user correctly identified the object displayed on the primary device. If so, a user profile associated with the user may be updated to indicate a reward.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative interactive media guidance application display screen in accordance with some embodiments of the present disclosure;

FIG. 2 shows another illustrative interactive media guidance application display screen in accordance with some embodiments of the present disclosure;

FIG. 3 illustrates an example of a user device, such as a primary device or a secondary device, in accordance with some embodiments of the present disclosure;

FIG. 4 illustrates an example of a system that enables user interaction with promotional content on a secondary device in accordance with some embodiments of the present disclosure;

FIG. 5 illustrates a system that includes a secondary device configured to receive a user selection of an object embedded in media content displayed on a primary device in accordance with some embodiments of the present disclosure;

FIG. 6 illustrates a system that includes a secondary device configured to capture a photograph of an object embedded in media content displayed on a primary device in accordance with some embodiments of the present disclosure;

FIG. 7 illustrates a system that includes a primary device on which enhanced media content is displayed in response to user completion of a promotional opportunity presented on a secondary device in accordance with some embodiments of the present disclosure;

FIG. 8 shows a system for generating a promotional opportunity on a secondary device and validating a responsive user submission in accordance with some embodiments of the present disclosure;

FIG. 9 illustrates a flow chart of an exemplary process for providing a promotional opportunity to a secondary device in accordance with some embodiments of the present disclosure;

FIG. 10 illustrates a flow chart of an exemplary process for determining whether a user correctly identified an embedded object in accordance with some embodiments of the present disclosure;

FIG. 11 illustrates a flow chart of another exemplary process for determining whether a user correctly identified an embedded object in accordance with some embodiments of the present disclosure; and

FIG. 12 illustrates a flow chart of an exemplary process for determining whether a user captured a photograph of an embedded object in accordance with some embodiments of the present disclosure.

### DETAILED DESCRIPTION OF THE VARIOUS EMBODIMENTS

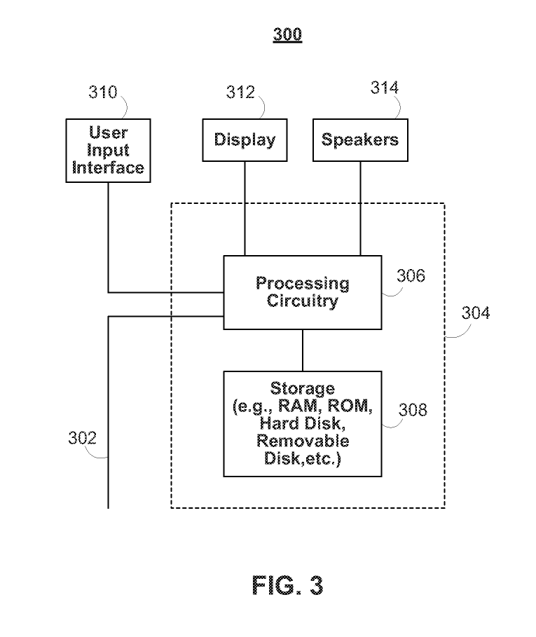

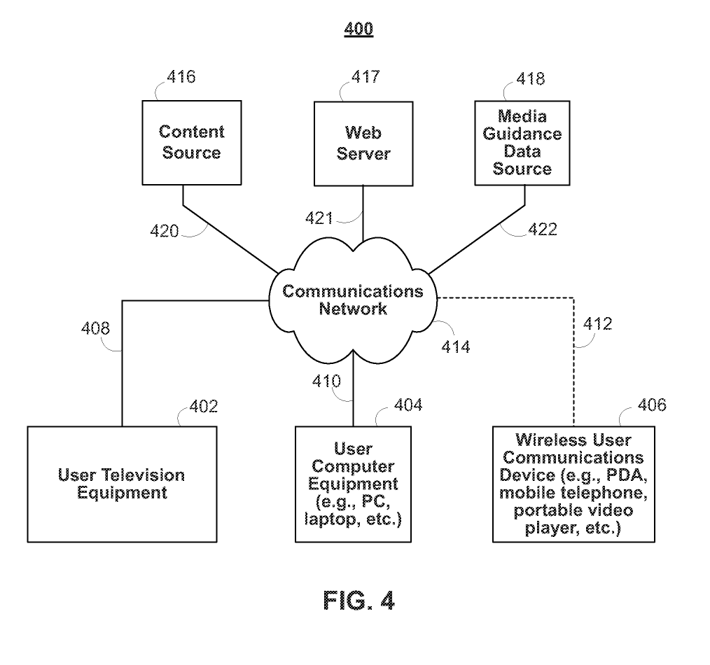

Systems and methods for incentivizing user interaction with promotional content on a secondary device are provided herein. A secondary device, discussed below in connection with FIG. 4, is a “second screen device” that supplements content presented on a primary (or “first”) device. The primary device may be any suitable user equipment device, described below in connection with FIG. 4 (and illustrated in FIG. 3), including a television or desktop computer. The secondary device may also be any suitable user equipment device, described below in connection with FIG. 4 (and illustrated in FIG. 3), including a phone (touch-sensitive or otherwise) or tablet computer. Although the secondary device is generally portrayed herein as a smaller and more mobile device than the primary device, it should be understood that the primary device may be smaller and more mobile than the secondary device, or that the two devices may be comparable in size, mobility, and processing capability, and may even be two of the same type of device.

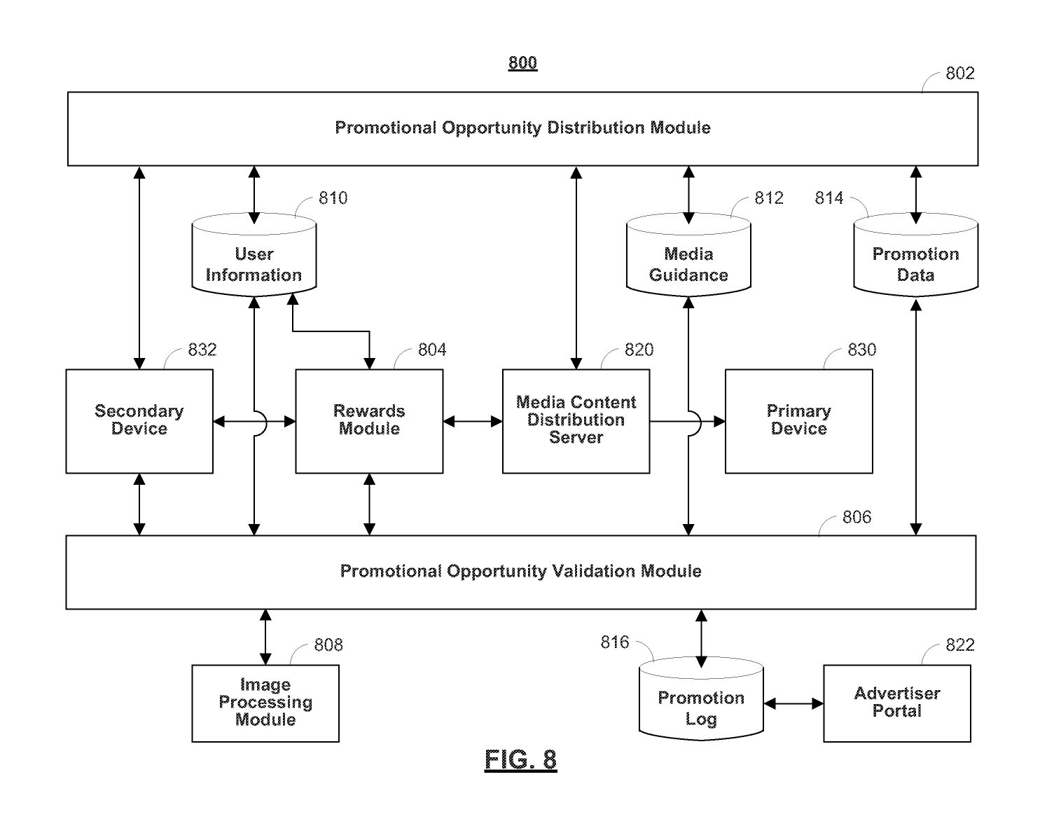

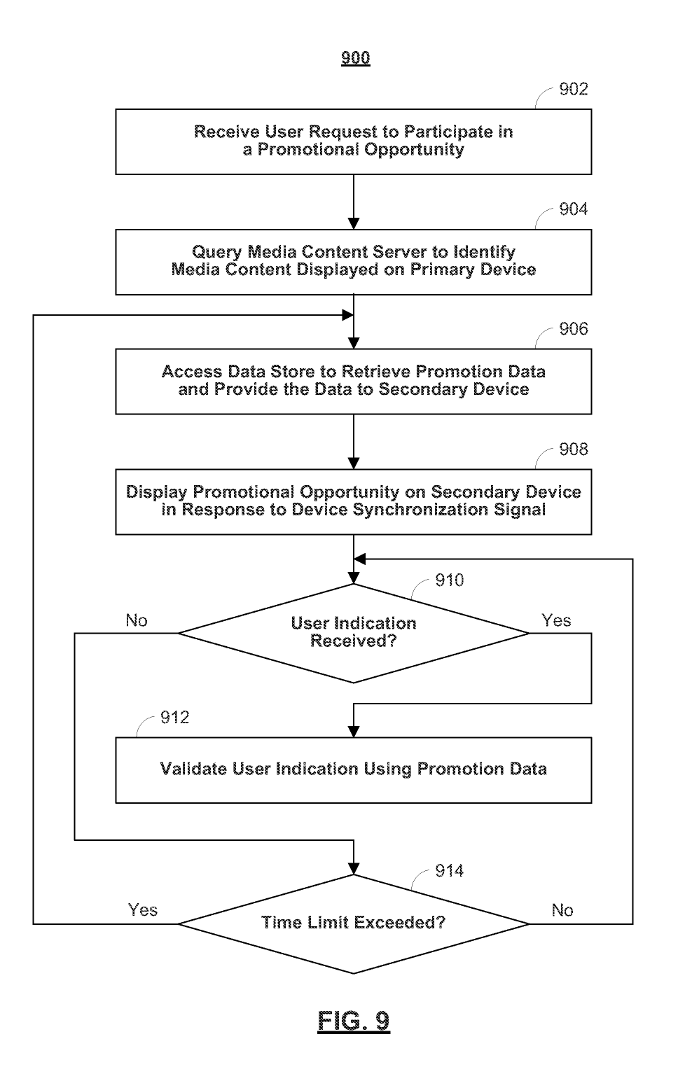

The secondary device may be synchronized with the media content displayed on the primary device to provide promotional opportunities relevant to the displayed content. The phrase “media content displayed on a primary device” is also referred to herein as “primary media content.” Synchronizing the two devices may be achieved through any suitable technique, such as a registration or handshaking procedure between the devices or through a remote server configured to manage secondary devices. Device synchronization is discussed further below in connection with FIGS. 8 and 9. Once the secondary device is synchronized with the primary device, it may receive data associated with one or more promotional opportunities (e.g., the data may be downloaded from a remote server). The received data may be used to generate a promotional opportunity corresponding to the media content displayed on the primary device. In some embodiments, the promotional opportunity may prompt the user to identify an object embedded within the primary content. The process of receiving data defining a promotional opportunity and generating a corresponding display screen on the secondary device is described further below in connection with FIGS. 8-12.

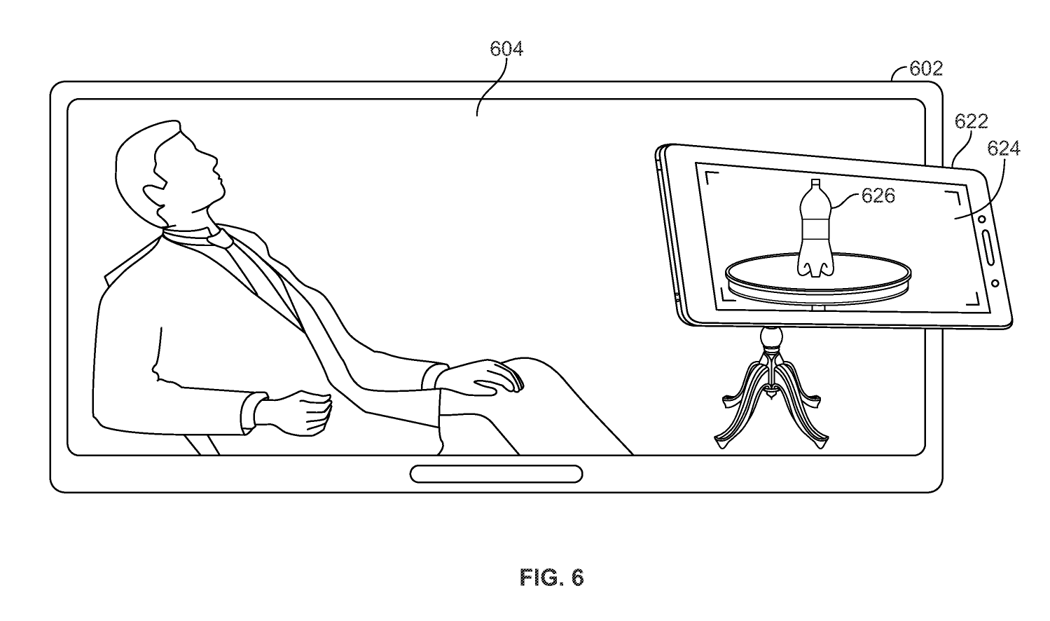

In some embodiments, the secondary device may allow a user to identify an object embedded within the primary media content. For example, the user may select the embedded object from a display screen on the secondary device that presents (a) another instance or copy of the primary media content, (b) a screenshot of a particular scene of the primary media content, or (c) a set of objects provided as part of a game. Of course, any suitable display screen presenting the object or information pertaining to the object may be used, as discussed in further detail below. The secondary device may have a touch-sensitive screen and the object selection may be indicated via user actuation of the touch-sensitive display screen at the location of the object (or information pertaining to the object). As another example, the user may use the secondary device to capture a photograph of the embedded object as displayed on the primary device, or to capture a photograph of a product similar to the embedded object. The photograph may be provided to a remote server for analysis and confirmation that it depicts the embedded object, or the analysis may be done locally, as discussed further below in connection with FIGS. 6, 8 and 12.

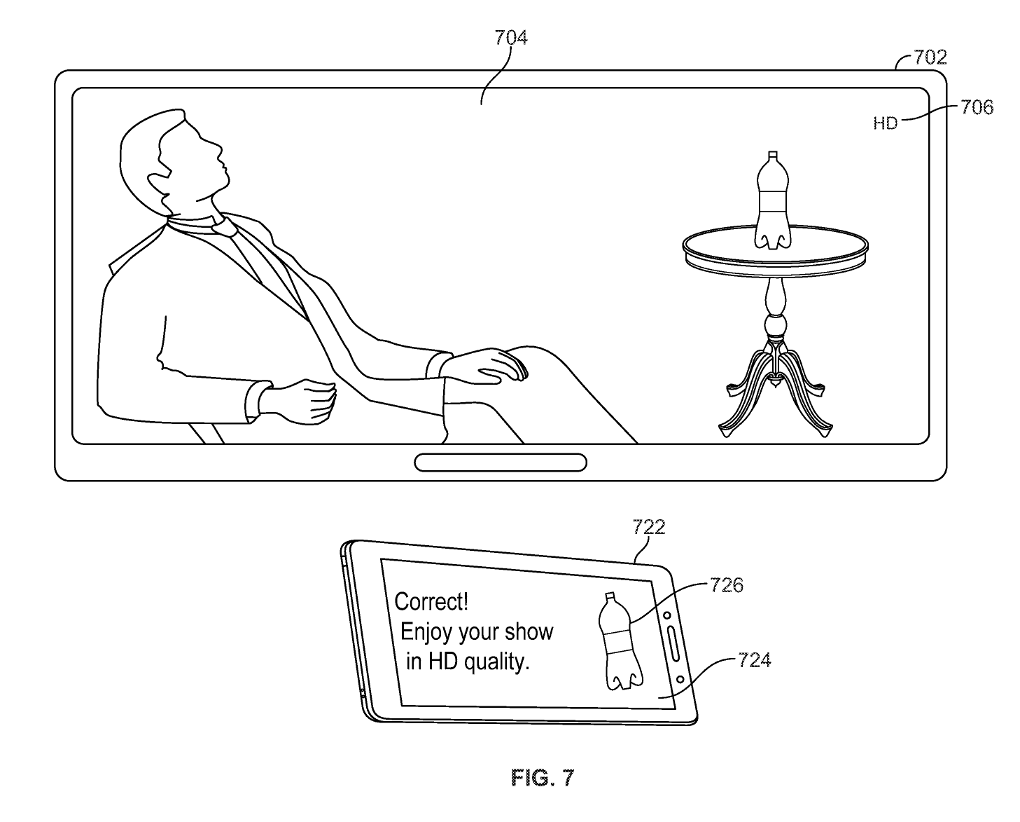

In some embodiments, the user identification of the embedded object is used to reward the user. For instance, the user may receive points redeemable for real products or consumption benefits, such as commercial-free viewing, higher quality streaming, or free access to otherwise pay programming. User submission tracking and reward schemes are discussed further below in connection with FIGS. 7 and 8. Thus, the user has an incentive to participate in the promotional opportunity provided on the secondary device. Moreover, since the promotional opportunity is provided on the secondary device, it does not disrupt viewing activity on the primary device. Finally, advertisers are provided with a way to reinforce the promotional effect of product placements in media content, while also deriving useful information on the effectiveness of the product placements and promotional opportunities.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

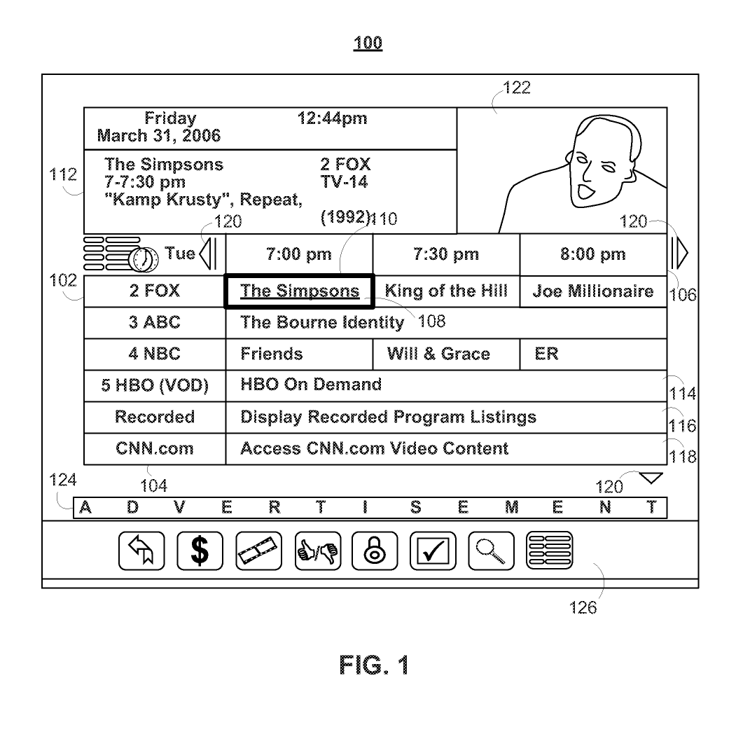

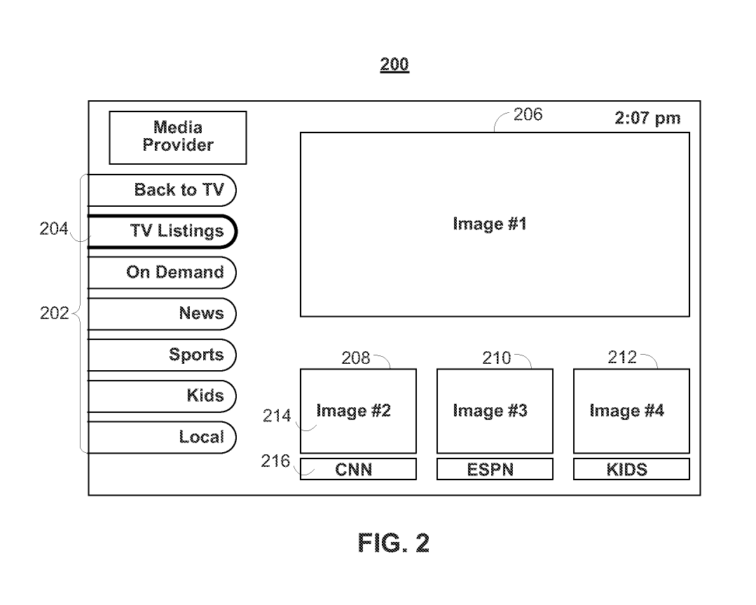

FIGS. 1-2 show illustrative display screens that may be used to provide media guidance data. The display screens shown in FIGS. 1-2 and 5-7 may be implemented on any suitable user equipment device or platform. While the displays of FIGS. 1-2 and 5-7 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

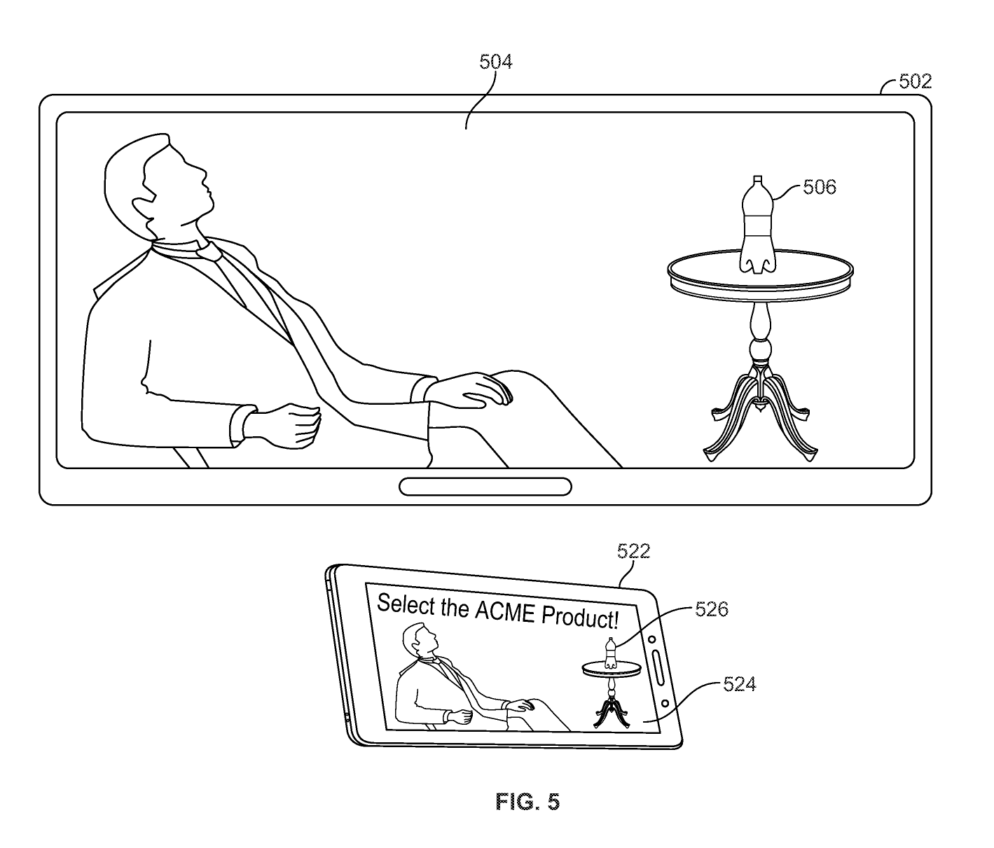

FIG. 5 shows an illustrative system that includes a primary device 502 and secondary device 522 in accordance with some embodiments of the present disclosure. As shown, secondary device 522 is configured to receive a user selection of an object embedded within media content displayed on primary device 502. In particular, primary device 502 may present display screen 504 depicting media content, e.g., a television show, a music video, or an Internet video stream. An object 506 may be embedded within the media content. Object 506 may be any type of visual object associated with an advertiser. For example, object 506 may be a product placement, i.e., a branded product recognizably displayed as part of a scene of a program. As another example, object 506 may be a logo associated with a sponsor. Although shown as a single object, object 506 may represent a series of objects associated with an advertiser.

In some embodiments, the media content presented on display screen 504 may be replicated on secondary device 522. Specifically, secondary device 522 may present display screen 524 presenting the same media content being displayed by primary device 502. Thus, object 506 may be replicated on the secondary device as object 526. In one approach, the media content is displayed on secondary device 522 in real-time, in synchronization with the media content displayed on primary device 502. The user may be able to pause the content at any point, e.g., by selecting an appropriate control button. In an alternative approach, secondary device 522 displays screenshots, or stills, of the media content displayed on primary device 502. In this approach, for instance, each scene or portion of the media content may be associated with its own representative still image; when a new scene is displayed on primary device 502, the corresponding still image is displayed on secondary device 522.

Display screen 524 on secondary device 522 may allow, or prompt, the user to select an object associated with an advertiser. A particular advertiser may or may not be specified to the user (e.g., there could be multiple products associated with multiple advertisers, and the user may be rewarded for a selection of any of those products). As shown, for instance, display screen 524 prompts the user to select the displayed product associated with the ACME Company. The user may then analyze the media content to identify the product. For example, if familiar with the ACME logo, the user may search the media content for an object that exhibits the ACME logo. The user may then select the object in the display screen. If the user correctly selects the object (i.e., object 526) the user may be notified and/or rewarded.

A user may select the object in display screen 524 using any suitable interface provided by secondary device 522. For example, the user may navigate a highlight or cursor over the object to select it. As another example, when secondary device is touch-sensitive, the user may actuate the screen in the location of the object. In some embodiments, display screen 524 contains video content and the user must first pause that content in order to select the object. A first user actuation of the screen may therefore pause the content, while the second user actuation selects the object. Of course, in embodiments where display screen 524 depicts still images from the media content displayed on primary device 502, pausing the content on secondary device may be unnecessary and the first user actuation determines the location of the selected object.

In some embodiments, instead of replicating the media content displayed on primary device 502 or displaying still images therefrom, display screen 524 depicts object 526 together with other objects, which may or may not also be featured in the media content. A user may then be prompted to select the appropriate object from among the options. In yet another embodiment, the user may be prompted to select the advertiser associated with object 526 from among different advertiser options. Other suitable display screens may also be used to engage the user in matching the advertiser to the product depicted as object 526. Upon receiving the user selection, secondary device 522 may itself, or in communication with an external server, validate the user's selection. Features pertaining to validating the user's selection and rewarding the user for successful identification are described further below in connection with FIG. 8.

FIG. 6 shows an illustrative system that includes a primary device 602 and secondary device 622 in accordance with some embodiments of the present disclosure. Primary device 602 may be substantially the same as primary device 502 of FIG. 5 and display screen 604, presented by primary device 602, may be substantially the same as display screen 504 of FIG. 5. As shown, secondary device 622 is configured to capture a photograph of an object embedded in media content displayed on primary device 602. In particular, primary device 602 may present display screen 604 depicting media content, e.g., a television show, a music video, or an Internet video stream. An object (e.g., corresponding to object 506 of FIG. 5) may be embedded within the media content. The object may be any type of visual object associated with an advertiser, as discussed above in connection with FIG. 5.

Instead of selecting the object from display screen 624 of secondary device 622, as in FIG. 5, secondary device 622 may be used to photograph the object displayed on primary device 602. Specifically, secondary device 622 may include a camera, and display screen 624 may allow the user to view and initiate the capture of a photograph. As shown, the user may focus and/or zoom the camera in order to emphasize the object in the image to be captured. Secondary device 622 may capture object 626 and save the photograph to a memory within the device or to an external storage. Thus the camera feature of device 622 serves to enable the user to substantially isolate an image of the object as displayed on primary device 602. Such image may then be validated to determine whether the user successfully photographed an image of the embedded object corresponding to a product placement. Features pertaining to validating the user's photograph of the embedded object and rewarding the user for successful identification are described further below in connection with FIGS. 8-12.

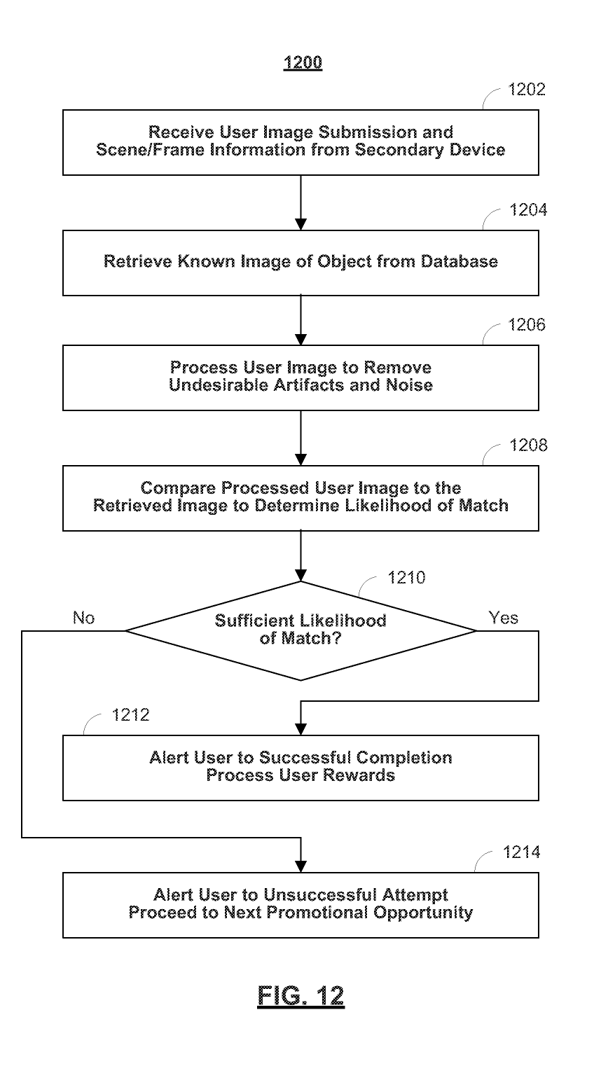

In other embodiments, instead of capturing the object embedded within the media content displayed on primary device 602, the user may be required to photograph a real-life product corresponding to the embedded object. Thus, the user may use secondary device 622 to capture an image of the real-life product and save the photograph to a memory within the device or to an external storage. The captured image may then be analyzed to determine whether the user successfully captured a product corresponding to (or related to) the embedded object. Features pertaining to validating the user's photograph of the real-life product and rewarding the user for successful identification are described further below in connection with FIGS. 8 and 12.

FIG. 7 illustrates a system that includes a primary device 702 on which enhanced media content is displayed in response to user completion of a promotional opportunity presented on a secondary device 722, in accordance with some embodiments of the present disclosure. Specifically, FIG. 7 provides an illustrative example of rewarding the user for successfully identifying an object embedded within media content (i.e., corresponding to a product placement). In this example, the playback quality of media content on the primary device 702 is enhanced, in this case to high-definition (HD). Thus, the user may receive an immediate reward for participating in a promotional opportunity using a secondary device, where the reward is an enhanced viewing experience of the media content being displayed on the primary device.

Of course, the user may be rewarded in any suitable way: in some approaches, the user's present viewing experience may be enhanced, in other approaches the user's future viewing experience may be enhanced, and in still other approaches the user may receive reward points redeemable for products or services. Examples of enhanced viewing experiences include higher quality audio and/or video, longer periods of viewing without commercial interruption, commercial-free viewing (or commercial-skipping capability), or any other suitable enhancement. Examples of products and services, which may be “purchased” using reward points, include pay programming, coupons, or retail items. Features pertaining to rewarding a user for successful identification of a product placement are described further below in connection with FIG. 8. It should be understood that references herein to “commercials” or “advertisements” are intended to encompass both types of promotions. For example, commercial-free viewing should be understood to include advertisement-free viewing (e.g., streaming Internet video free of pop-up advertisements).

Referring again to FIG. 7, primary device 702 may be substantially the same as primary devices 502 and 602 of FIGS. 5 and 6, respectively. Display screen 704 may be presented by primary device 702 in response to a determination that the user correctly identified an embedded object corresponding to a product placement. As shown, the media content displayed by primary device 702 has been enhanced to HD quality. In some embodiments, an indication 706 is displayed within display screen 704 to alert the user to the change in quality. However, indication 706 may convey any suitable information, such as the type of reward obtained or the number of reward points in the user's account. Indication 706 may also be used to inform the user whether the object identification was correct, e.g., by displaying “Correct” or “Incorrect.” Indication 706 may take any suitable form, including text, graphics, video, or multimedia content, and may be overlaid over the media content. In one approach, indication 706 is displayed for a fixed period of time, at which point the indication may fade out of view.

Display screen 724 of secondary device 722 may also update in response to a user identification of the embedded object. As shown, display screen 724 may present the identified object 726 and/or a message notifying the user whether his identification was correct. In some embodiments, display screen 724 alerts the user to the reward received or provides the user with an option to redeem a reward. In other embodiments, display screen 724 allows the user to purchase the product or service associated with object 726. The user may also be provided with the ability to engage in another promotional opportunity, e.g., to identify another object embedded in the media content on primary device 702.

Turning to FIG. 8, illustrative system 800 is shown for generating a promotional opportunity on a secondary device and validating a responsive user submission, in accordance with some embodiments of the present disclosure. In particular, system 800 illustrates the various servers, modules, data stores, and devices that may communicate in order to (a) generate a promotional opportunity corresponding to media content being displayed on a primary device, (b) provide the promotional opportunity to a secondary device, and (c) process a user submission to validate and reward the user for a correct response. As will be described in more detail below, these servers, modules, data stores, and devices of system 800 may be used individually or in combination to generate and manage promotional opportunities on a secondary device, or otherwise perform the functions discussed below.

Promotional opportunity distribution module 802 receives and processes requests for promotional opportunities related to media content (“promotion requests”). Distribution module 802 may include any suitable hardware for receiving and processing requests, retrieving information from one or more data stores, and providing data to remote devices. For example, distribution module may be a server accessible through the Internet, which may include one or more general-purpose processors and/or other processing circuitry, which may in turn execute software. Distribution module 802 may be, for example, one of servers 416-418 of FIG. 4 or a different server connected to network 414 of FIG. 4. As shown, distribution module 802 may communicate with user information data store 810, media guidance data store 812, promotion data store 814, media content distribution server 820, secondary device 832, and/or advertiser portal 822. In some embodiments, distribution module 802 and promotional opportunity validation module 806 are conceptual parts of a single module that performs the functions of each, as discussed in greater detail below.

In some embodiments, distribution module 802 receives a promotion request from secondary device 832, e.g., initiated by an application running on the device. The application may be a proprietary “app” downloaded from the Internet or any other suitable software module. In some approaches, the application sends a promotion request to distribution module 802 when the application is launched, at periodic intervals, when initiated by the user, and/or at any other suitable time. In other approaches, the application sends a promotion request according to a predetermined schedule. For example, a user may launch a proprietary app from a phone or tablet computer (i.e., secondary device 832), which may send a request to distribution module 802 as part of it's startup sequence. The app may also provide a refresh button allowing the user to initiate subsequent requests as often as desired.

Promotion requests may include information pertaining to media content presented on primary device 830. In some embodiments, secondary device 832 communicates with primary device 830 (e.g., via infrared, Bluetooth, or WiFi) to determine the media content displayed by primary device 830. This procedure may include querying a cable box or other media hardware connected to the primary device, sending a request to a media guidance application running on the primary device, or querying a web browser or other software application running on the primary device. In other embodiments, the aforementioned application on secondary device 832 allows (or prompts) the user to specify the media content displayed on primary device 830. For example, the user may specify the name of the program, a channel or source providing the program, and/or other identifying information. The promotional request may also include the date and/or time the request was initiated, e.g., as automatically detected from an internal clock maintained on secondary device 832 or as determined from an external server. In yet other embodiments, the promotional request does not include any information pertaining to media content presented on primary device 830 (although it may still include time and date information).

Furthermore, promotion requests may include device information and/or user data. Specifically, a promotion request may include data identifying secondary device 832 such that distribution module 802 or another server may subsequently provide data to the device. For instance, the promotion request may include the device's Internet Protocol (IP) address. In addition, a promotion request may include a unique identifier for the user of the device, such that that distribution module 802 or another server may subsequently access and/or modify user data associated with the user, which may be stored in a remote data store, e.g., the user's profile, subscription information, or other user data.

Upon receiving a promotion request, distribution module 802 may provide secondary device 832 with one or more promotion opportunities for the media content displayed on primary device 830. First, distribution module 802 may attempt to detect the media content displayed on primary device 830. As mentioned above, this information may be contained in the promotion request provided by secondary device 832. In that case, distribution module 802 may simply parse the information from the promotion request. Otherwise, distribution module 802 may determine the identity of the media content using user information data store 810, media guidance data store 812, and/or media content distribution server 820.

In one approach, distribution module 802 communicates directly with server 820 to determine the media content being provided to primary device 830. For example, distribution module 802 may retrieve cable subscription information from data store 810 (using the unique identifier provided with the promotion request) and use that information to query a cable television headend (server 820) for the currently tuned or broadcast program. As another example, distribution module 802 may retrieve user account settings from data store 810 (using the unique identifier provided with the promotion request) to query an Internet video streaming server (server 820) for the current program being streamed to the user. In another approach, distribution module 802 communicates with media guidance data store 812 to access media listings for programs currently available (or, programs available at the time indicated in the promotion request). These listings may be filtered using user information from data store 810 to produce a set of listings corresponding to media content accessible to the user (i.e., which the user's subscription information indicates the user can access). Distribution module 802 may then correlate these listings with promotional opportunity data from data store 814 to determine which of the listings correspond to programs for which promotional data is available. The resulting set of listings may be used to prompt the user to select the media content displayed on primary device 830. Specifically, distribution module 802 may send an information packet to secondary device 832 that includes a set program names (which, by the process described above, includes only media content both accessible by the primary device and for which a promotional opportunity exists). Secondary device 832 may then prompt the user to select one of the programs and, in turn, may provide the user selection back to distribution module 802.

Regardless of the mechanism used to determine the media content displayed on primary device 830, distribution module 802 may access promotional data store 814 to determine if a promotional opportunity exists for that media content. In some embodiments, distribution module 802 determines whether a promotional opportunity exists for the currently displayed media content or media content scheduled to be displayed (e.g., the next program scheduled to be broadcast on that channel or source, or the next program in the user's media queue). If no promotional opportunity is available, distribution module 802 may cause a message to be displayed notifying the user of secondary device 832. Otherwise, distribution module 802 may retrieve the relevant promotional data from data store 814 and provide the data to secondary device 832.

Promotional data may include any suitable information required by secondary device 832 to display a promotional opportunity. In some embodiments, promotional data includes a real-time video stream of the media content synchronized with the primary device. In other words, distribution module 802 may provide secondary device 832 with a copy of the media content displayed on primary device 830, timed to substantially track the display of the content on the primary device. In addition, to this video stream, distribution module 802 may provide data defining an object embedded within the media content, e.g., metadata defining the timing and location of the object. For instance, metadata may include the x, y coordinates of the embedded object and a time frame during which the object appears on-screen. In another approach, the object may be its own interactive element responsive to user interaction. In yet other approaches, the promotional data does not include information specific to the embedded object, but the user may select a portion of the displayed media content as discussed below.

In other embodiments, promotional data includes still images of the media content displayed on primary device 830. Promotional data may also including timing information that specifies when to display these still images relative to the media content on primary device 830. For instance, the promotional data may tag each still image with a scene of the media content, to be displayed when the scene is displayed on the primary device 830. The promotional data my also include data defining an object embedded within a still image, e.g., metadata defining the location (e.g., x, y coordinates) of the object. In another approach, the object may be its own interactive element responsive to user interaction. In yet other approaches, the promotional data does not include information specific to the embedded object, but the user may select a portion of the still image as discussed below.

In either of these embodiments, secondary device 832 may use the promotional data to generate a display screen presenting the object as depicted in a scene of the media content (e.g., display screen 524 of FIG. 5. The object may correspond to a product placement associated with an advertiser. The display screen may additionally prompt the user to select the object, e.g., by challenging the user to identify an object associated with a given advertiser. The user may then interact with the display screen to select the portion of the screen the user believes contains the object. When the promotional data contains the location information of the object, or when the object is an interactive element, secondary device 832 may determine whether the user successfully identified the correct object. For instance, the device may compare the location of the user selection to the known coordinates of the object as provided by the promotional data. The results of the comparison (i.e., whether the user was successful or unsuccessful) may be provided to the user as a notification and/or transmitted to promotional opportunity validation module 806. When the promotional data does not contain location information for the object, however, the coordinates of the user selection may be provided directly to promotional opportunity validation module 806, which may determine whether the user identified the correct object, as discussed in greater detail below.

In some embodiments, promotional data includes the object embedded within the media content displayed on primary device 830 along with other objects, which may be from the same or a different advertiser. The objects may be displayed on secondary device 832, and the user may be prompted to select the object displayed within the media content. The user selection may be relayed to promotional opportunity validation module 806. In still other embodiments, the promotional data may include the object and a list of advertisers, only one of which is correctly associated with the object. In this case, secondary device 832 may prompt the user to select the correct advertiser from among the other choices. Again, the user selection may be provided to promotional opportunity validation module 806 for further processing.

It should be understood that promotional data may contain any suitable data pertaining to the embedded object, and that the promotional opportunity may require the user to identify the object, the advertiser of the object, or otherwise match the object to the advertiser. The promotional data may be retrieved from data store 814 by distribution module 802 in response to a request from secondary device 832, and provided to secondary device 832 for display. In turn, secondary device 832 may receive user interaction in the context of the promotional opportunity, and may determine whether the user successfully completed the task provided by the opportunity. Alternatively, secondary device 832 may provide the user interaction to validation module 806 for the determination. For example, secondary device 832 may receive a user selection of a region of the display corresponding to what the user believes is the embedded object. Secondary device 832 may use promotional data to determine whether the user identified the embedded object correctly, or may forward the user selection information to validation module 806, which may determine whether the user identified the embedded object correctly.

Validation module 806 may include any suitable hardware for receiving and processing requests, retrieving information from one or more data stores, and providing data to remote devices. For example, validation module 806 may be a server accessible through the Internet, which may include one or more general-purpose processors and/or other processing circuitry, which may in turn execute software. Validation module 806 may be, for example, one of servers 416-418 of FIG. 4 or a different server connected to network 414 of FIG. 4.

As noted above, validation module 806 may receive, from secondary device 832, user input data associated with a promotional opportunity or an indication of the outcome of a promotional opportunity. In the former scenario, validation module 806 may determine whether the user successfully completed the promotional opportunity. For example, validation module 806 may retrieve promotional data from data store 814 corresponding to the promotional opportunity displayed on secondary device 832. Validation module 806 may then compare the user input data to the expected input data to determine whether the user succeeded. For example, when the promotional opportunity requires identification of the object on-screen, validation module 806 may compare the location of the user selection to the known location of the embedded object. If the locations match, validation module 806 determines that the user successfully identified the embedded object. As another example, when the promotional opportunity requires the user to identify the correct advertiser or object, validation module 806 may compare the user's selection to the correct answer to determine the result.

Whether or not the user successfully completes the promotional opportunity, validation module 806 may perform a number of tasks. Specifically, validation module 806 may provide a notification to secondary device 832 for display to the user. The notification may indicate whether or not the user was successful. In addition, validation module 806 may communicate with user information data store 810 to store an indication that the user participated in the promotional opportunity. This indication may facilitate distribution module 802 in selecting an appropriate promotional opportunity in the future. For example, before selecting a promotional opportunity for the user, distribution module 802 may determine whether the user has been previously presented with the particular promotion, i.e., by cross-referencing the promotion with the information stored in data store 810. Finally, validation module 806 may store the results of the promotion in log data store 816. Log data store 816 may contain the promotion results for each promotional opportunity in the system, and may be updated each time a user interacts with a promotional opportunity. This data may then be accessed to determine promotion effectiveness and success rate, as discussed further below.

When the user successfully completes the promotional opportunity (e.g., identifies the correct object), validation module 806 may communicate with rewards module 804 to provide the user with a reward. Rewards module 804 may include any suitable hardware for receiving and processing requests, retrieving information from one or more data stores, and providing data to remote devices. For example, module 804 may be a server accessible through the Internet, which may include one or more general-purpose processors and/or other processing circuitry, which may in turn execute software. Module 804 may be, for example, one of servers 416-418 of FIG. 4 or a different server connected to network 414 of FIG. 4. In some embodiments, rewards module 804 and validation module 806 are different conceptual parts of a single module (i.e., server). For instance, the functions of modules 804 and 806 may be implemented using the same processing hardware.

Each promotion may be associated with a predetermined reward, and validation module 806 may retrieve the reward information from promotional data store 814 and may pass that information on to rewards module 804. In one approach, the user is immediately rewarded with an enhanced viewing experience, such as an increase in playback quality or a reduction in the frequency of commercial interruption. Rewards module 804 may thus communicate with media content distribution server 820 to modify the delivery options for the media content being displayed on primary device 830. For example, rewards module 804 may set the delivery options to enhance the resolution of the media content provided to primary device 830. As another example, rewards module 804 may set the delivery options so that the media content is delivered to primary device 830 commercial-free, or with a reduced frequency of commercial interruption. In another approach, the user is rewarded with a future enhanced viewing experience. Specifically, when selecting new media content to view in the future, the user may be provided with an option to view the content in higher quality or with fewer commercials. This redeemable reward may be provided by server 820 to primary device 830 in response to a communication from rewards module 804.

In some embodiments, the reward may be in the form of reward points. Rewards module 804 may therefore be configured to update user information in data store 810 to add a number of reward points to the user's total. The number of reward points granted upon successful completion of a promotional opportunity may be preset, or may be specified by the promotional data in data store 814 for the given promotional opportunity. Thus, validation module 806 may access data store 814 to provide rewards module 804 with the number of points associated with the given promotional opportunity. An indication of the reward may also be stored in log 816 by validation module 806. Moreover, rewards module 804 may provide secondary device 832 with a notification of the reward received, which may be displayed to the user.

In some embodiments, a promotional opportunity may require the user to submit a photograph to validation module 806. For example, the user may be prompted to capture a photograph of an object embedded within media content displayed on primary device 830. As another example, the user may be prompted to photograph a real-life product (or logo) corresponding to the embedded object. The user may capture a photograph using secondary device 832 and upload the image to validation module 806. Validation module 806 may determine the promotional opportunity, as discussed above, and retrieve a known image from data store 814. Validation module 806 may then provide the user image and the known image to module 808 for processing and comparison.

Image processing module 808 may include any suitable hardware for receiving and processing requests, retrieving information from one or more data stores, and providing data to remote devices. For example, module 808 may be a server accessible through the Internet, which may include one or more general-purpose processors and/or other processing circuitry, which may in turn execute software. Module 808 may be, for example, one of servers 416-418 of FIG. 4 or a different server connected to network 414 of FIG. 4. In some embodiments, module 808 and validation module 806 are different conceptual parts of a single module (i.e., server). For instance, the functions of modules 806 and 808 may be implemented using the same processing hardware. Image processing module 808 may employ any known technique to identify and isolate the photographed object from the user's image, and to reduce any noise that may be present in the image. Image processing module 808 may then compare the processed image to the known image to determine the likelihood of a match. The image comparison process may include cross-correlation, filtering, and/or pixel-to-pixel comparisons. When the likelihood of a match exceeds a threshold, validation module 806 may determine that the images sufficiently match and may reward the user as discussed above.

In some embodiments, system 800 includes advertiser portal 822, which may be a server that provides access to the data stored in log data store 816. Advertiser portal 822 may include any suitable hardware for receiving and processing requests, retrieving information from one or more data stores, and providing data to remote devices. For example, portal 822 may be a server accessible through the Internet, which may include one or more general-purpose processors and/or other processing circuitry, which may in turn execute software. Advertiser portal 822 may be, for example, one of servers 416-418 of FIG. 4 or a different server connected to network 414 of FIG. 4. In some embodiments, portal 822 and validation module 806 are different conceptual parts of a single module (i.e., server). For instance, the functions of module 806 and portal 822 may be implemented using the same processing hardware.

Advertiser portal 822 may provide advertisers or other users information about promotional opportunities, including the number of user who have engaged with the opportunity, the success rate, and other relevant factors. Advertiser portal 822 may also communicate with distribution module 802 to allow advertisers to modify promotional opportunities. For instance, an advertiser may enable or disable an opportunity, or limit the number of user who may successfully complete a promotion.

The following flow diagrams serve to illustrate processes involved in some embodiments of the present disclosure. Where appropriate, these processes may, for example, be implemented completely in the processing circuitry of a user equipment device (e.g., processing circuitry 304 of FIG. 3) or may be implemented at least partially in a source remote from the user equipment devices (e.g., media guidance source 418 of FIG. 4 or modules 802, 804, 806, and 808 of FIG. 8).

Turning to FIG. 9, illustrative flow chart 900 is shown depicting an exemplary process for providing a promotional opportunity to a secondary device in accordance with some embodiments of the present disclosure. At step 902, a user request is received for a promotional opportunity. For example, secondary device 832 of FIG. 8 may initiate a promotion request to distribution module 802. As discussed above, a promotion request may include user information (e.g., a unique identifier), device information for the secondary device (e.g., an IP address), and/or information identifying media content displayed on a primary device (e.g., the title of the media content, the channel/source of the media content, a program code, etc.). A promotion request may also include a timestamp of the time and date when the request was initiated. Finally, a promotion request may include device information for the primary device (e.g., an IP address), which the secondary device may access and retrieve.

At step 904, a media content server (e.g., server 820 of FIG. 8) is queried to identify the media content displayed on the primary device (e.g., device 830 of FIG. 8). It should be understood that this step might not be necessary when the promotion request includes sufficient information identifying the media content. The user information included within the promotion request may be used to access account settings or subscription information for the user, which may then be used to query the media content server for the media content currently being viewed by the user. For example, in a scenario where the user is watching television or a video-on-demand program using a set-top box, the media content server may determine the currently viewed program from data records for that user, or by communicating with the user's set-top box. As another example, in a scenario where the user is streaming video from an Internet service, the media content server may determine the currently viewed program from an internal log or other database of usage data. The media content server may then provide information identifying the media content.

It should be understood that any of the user or device information included within the promotional request may be used by the media content server to identify the media content displayed on the primary device. For instance, user information may be used to look up the user's account or subscription settings, which may then be used to retrieve the user's current usage data. Alternatively, or additionally, device information for the primary device may enable the media server to directly communicate with the primary device to determine the media content currently displayed. Finally, in some embodiments, the timestamp included with the promotional request may enable the media server to adjust for time delay, so that the information returned identifies the media content displayed at the time the request was initiated.

When the media content displayed on the primary device is not directly identifiable, the user may be prompted to enter the information manually on the secondary device. In some embodiments, the user may be provided with an option to select from a limited set of media content titles. This limited set may be produced based on user information and/or data on available promotional opportunities. For instance, the system may first determine the set of media content titles currently available that have associated promotional opportunities. That set may further be filtered using user information to determine which of those media titles the user has access to on the primary device. For example, user subscription information may be used to rule out the possibility that the user is watching a show on a channel or source to which the user is not subscribed. Of course, these two pruning steps may be performed in the opposite order, and/or may be performed only when a sufficiently small number of promotional opportunities are available.

At step 906, a database of promotional data (e.g., data store 814 of FIG. 8) is accessed to retrieve promotional data associated with the media content displayed on the primary device (and identified in step 904). The promotional data may be categorized or associated with metadata that enables retrieval using information associated with the media content, e.g., the promotional data and the media content may both include the same unique code or identifier. In addition, more than one promotional opportunity may be retrieved for media content, e.g., when a show contains multiple product placements. Promotional data may include any and all necessary information required to generate a promotional opportunity. For instance, promotional data may include text, graphics, video, audio, and/or multimedia content. Alternatively, promotional data may merely include a link to a web site that displays the promotional opportunity. As another alternative, promotional data may be a hypertext markup language (HTML) file or extensible markup language (XML) file containing links to media objects accessible from the Internet. It should be understood that promotional data may be a single file or a collection of files, and may include the object embedded in the media content on the primary display.

Continuing with step 906, the retrieved promotional data may be provided to the secondary device for display to the user. The process of generating the promotional opportunity and determining when to display the opportunity to the user is discussed below in connection with step 908. In some cases, however, a promotion may not be available for the media content displayed on the primary device. For example, a query of the promotional data store may indicate that no promotional opportunities exist, that they are currently unavailable, or user data may indicate that the promotional opportunity has already been displayed to the user. In such a scenario, the user may be notified, on the display screen of the secondary device, that no promotions are available. In some embodiments, the user will be informed of other opportunities, e.g., for other currently available media content or for media content scheduled to be available in the future. In other embodiments, a default promotional opportunity, which may or may not be related to the media content displayed on the primary device, is retrieved from the promotional data store and provided to the secondary device.

At step 908, the promotional opportunity is displayed by the secondary device. The secondary device may use any suitable software to generate the promotional opportunity. For example, the secondary device may launch a web browser or may render the promotional opportunity within a proprietary application. In some embodiments, the promotional opportunity is displayed immediately upon receipt by the secondary device. In other embodiments, the promotional opportunity is timed for display relative to the media content displayed on the primary device. For instance, the promotional opportunity may be timed to coincide with a particular scene of the media content, e.g., when the product placement appears on-screen. Specifically, a promotional opportunity may be associated with a scene or a specific time marker within the media content. In this case, it is necessary for the secondary device to track the timing of the media content on the primary device.

In one approach, the secondary device may use schedule information associated with the media content, i.e., as provided by a media guidance database (e.g., data store 812 of FIG. 8), to detect the appropriate time to display each promotional opportunity. In particular, secondary device may determine the scheduled start time of the media content, and may display the promotion when the corresponding portion of the media content is expected to be displayed on the primary device. Alternatively, instead of using schedule information, secondary device may receive data (e.g., from the media content server) indicating when the user began viewing the media content.

In another approach, the promotional opportunity is displayed in response to a device synchronization signal. The secondary device may receive the synchronization signal from any suitable source, including the media content server or the primary device itself. For instance, referring to FIG. 8, the synchronization signal may be produced by media content distribution server 820 in response to determining that a particular portion of the media content is being displayed on (or transmitted to) primary device 830. In some embodiments, the media content may contain markers at certain frames triggering the generation of a synchronization signal. In another approach, the synchronization signal is generated by distribution module 802 of FIG. 8 in response to determining an elapsed time of the media content being displayed on (or provided to) primary device 830. For example, the distribution server 802 may query media content server 820 for the elapsed time of the media content, and may then correlate the elapsed time to data stored in promotional data store 814 to determine when a promotional opportunity is to be displayed. In response to that determination, distribution server 802 may generate the synchronization signal.

In some embodiments, the synchronization signal may indicate the scene or elapsed time of the media content on the primary device. The secondary device may compare this information to the promotional data to determine the appropriate time to display the promotion. Accordingly, the synchronization signal may be provided to secondary device periodically, or the secondary device may request the signal at suitable points. For instance, the secondary device may request a synchronization signal at relatively infrequent intervals until it determines that the scene associated with the promotional data is within a given timeframe, at which point it may increase the frequency of its requests. In other embodiments, the synchronization signal may itself indicate the exact time to display the promotional opportunity, and the secondary device may respond to receiving the signal by immediately displaying the promotion.

When multiple promotional opportunities are provided to the secondary device, the appropriate promotional opportunity may be displayed at a time indicated by the promotional data. For example, each promotional opportunity may be associated with a scene or a specific time marker within the media content. The secondary device may use schedule information about the media content, i.e., as provided by the media content server, to detect the appropriate time to display each promotional opportunity. Alternatively, the secondary device may receive indications from a remote server (e.g., the aforementioned synchronization signal) indicating when to display each opportunity. In other embodiments, the promotional opportunities may not be timed to coincide with the media content displayed on the primary device. For instance, the promotional opportunities may be displayed in a preset order, or randomly. Each promotional opportunity may then be displayed sequentially as they are completed by the user, or after a certain time interval has elapsed.

The promotional opportunity may be displayed to the user for a particular amount of time (e.g., for the duration of the associated scene of the media content, for a preset time period, or until the user interacts with the promotion). As discussed above, the promotional opportunity may prompt the user to interact with the display screen of the secondary device, e.g., by selecting an object displayed on-screen or by capturing a photograph. Referring again to FIG. 9, the process determines whether such a user indication has been received at step 910. If not, the process proceeds to step 914, where it is determined whether time limit associated with the promotional opportunity has been exceeded. If it the promotion has expired (e.g., the scene is over), the process may return to step 906 (or step 908) to retrieve and/or display another promotional opportunity. If the promotion has not expired, the process may return to step 910. Thus, the process waits for a user indication until expiration of the promotional opportunity. If, at step 910, a user indication is received, the process proceeds to step 912, where the user's indication is validated, as explained further below.

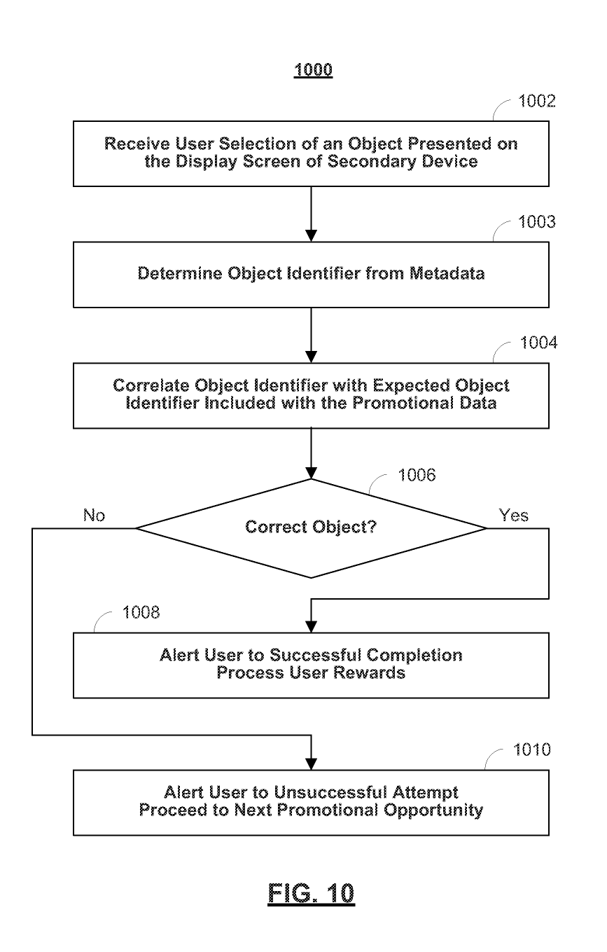

Turning to FIG. 10, illustrative flow chart 1000 is shown depicting an exemplary process for determining whether a user correctly identified an embedded object in accordance with some embodiments of the present disclosure. The depicted process is a technique for validating a user indication and, in some embodiments, is performed at step 912 of FIG. 9. At step 1002, a user selection of an object displayed on a secondary device is received. Specifically, the user may select the object from a display screen presenting a promotional opportunity. At step 1003, the selected object may be identified and at step 1004, it may be correlated with the promotional data to determine whether the selected object corresponds to the object embedded within the media content displayed on the primary device (i.e., a product placement). In one approach, the object may be identified using metadata associated with portions of the display screen. For example, the display screen may contain one or more interactive regions each associated with an object identifier. In another approach, the object itself may be interactive and may include metadata indicating an object identifier. In addition, the promotional data may include data identifying the object (i.e., an expected object identifier). Thus, the promotional data may be compared to the object identifier associated with the user-selected region or object to determine whether the information matches. For example, the promotional data and the aforementioned object identifier may be compared. At step 1006, it is determined whether the correct object has been identified. If so, the process may proceed to step 1008, where the user is notified of the successful identification and provided with a reward (e.g., enhanced viewing experience or reward points). If the user misidentified the object, the process may proceed to step 1010, where the user is notified of the unsuccessful attempt and prompted to participate in another promotional opportunity.

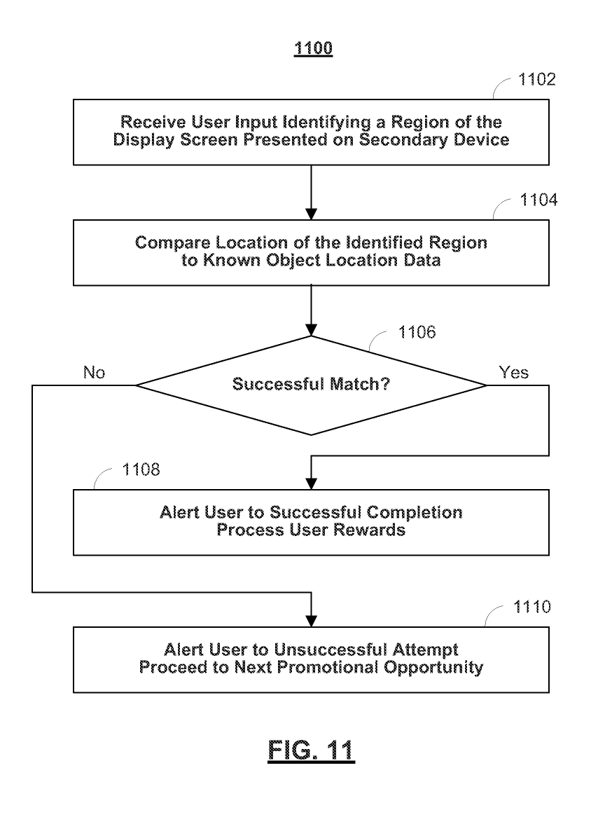

FIG. 11 shows illustrative flow chart 1100, which depicts another exemplary process for determining whether a user correctly identified an embedded object in accordance with some embodiments of the present disclosure. The depicted process is a technique for validating a user indication and, in some embodiments, is performed at step 912 of FIG. 9. As opposed to the process of FIG. 10, flow chart 1100 provides a process for evaluating a user object selection when the display screen is not interactive. At step 1102, a user selection of a region of the display screen (presented by the secondary device) is received. Specifically, the user may indicate the location of an object from a display screen presenting a promotional opportunity. At step 1104, the location of the user indication may be compared to known object location data included within the promotional data. For instance, the x, y coordinates of the user indication may be compared to the x, y coordinates of a region defining the location of the embedded object. At step 1006, it is determined whether the correct object has been identified. Specifically, it is determined whether the user indicated portion of the display corresponding to the location of the embedded object. If the user correctly identified the location of the object, the process may proceed to step 1108, where the user is notified of the successful identification and provided with a reward (e.g., enhanced viewing experience or reward points). If the user misidentified the object, the process may instead proceed to step 1110, where the user is notified of the unsuccessful attempt and prompted to participate in another promotional opportunity.

Turning to FIG. 12, illustrative flow chart 1200 is shown depicting an exemplary process for determining whether a user captured a photograph of an embedded object in accordance with some embodiments of the present disclosure. The depicted process is a technique for validating a user indication and, in some embodiments, is performed at step 912 of FIG. 9. At step 1202, a user image submission is received from a secondary device. In some embodiments, the user image is accompanied by scene or frame information associated with media content displayed on a primary display. For instance, the secondary device may track the media content on the primary device and may include metadata with the image that specifies the portion of the media content playing at the time the photograph was captured. At step 1204, a known image of the embedded object may be retrieved from a database (e.g., data store 814 of FIG. 8). The known image may depict the object and the scene in which it appears, or the object alone. Although a single known image is discussed, it should be understood that a set of known images may be used in the comparison discussed in step 1208. Alternatively, no known image may be used at all, and the analysis is performed using data that describes certain features of the object, e.g., shape, shading, or other identifiable features.

At step 1206, the user image may be processed to remove noise and artifacts. The known image may be used in this process, for example, as part of a filter. The user image may also be processed to remove the background of the image, or to enhance certain features of the image. In some embodiments, the image may be processed to identify and isolate a foreground object (or to eliminate certain objects). It should be understood that any suitable digital image processing techniques may be used to extract and/or enhance certain visual aspects of the user-submitted image in preparation for the comparison step in step 1208. For example, the image may be filtered, color-corrected, scaled, rotated, etc. At step 1208, the processed user image may be compared with the known image retrieved at step 1204. The image comparison may involve any suitable processing techniques and may result in a value indicating a likelihood that the images match. For example, the comparison may involve correlation techniques, pixel-to-pixel analysis, masking, variance calculations, and/or feature detection. At step 1210, it is determined whether the calculated likelihood that the images match exceeds a threshold value. If so, the process proceeds to step 1212, where the user is notified of the successful identification and provided with a reward (e.g., enhanced viewing experience or reward points). Otherwise, the process may instead proceed to step 1214, where the user is notified of the unsuccessful attempt and prompted to participate in another promotional opportunity.

It will be apparent to those of ordinary skill in the art that methods, techniques, and processes involved in the present disclosure may be embodied in a computer program product that includes a non-transitory computer usable and/or readable medium. For example, such a non-transitory computer readable medium may consist of a read-only memory device, such as a CD-ROM disk or conventional ROM devices, or a random access memory, such as a hard drive device or a computer diskette, having a computer readable program code stored thereon.

It is to be understood that while certain forms of the present disclosure have been illustrated and described herein, it is not to be limited to the specific forms or arrangement of parts described and shown. Those skilled in the art will know or be able to ascertain using no more than routine experimentation, many equivalents to the embodiments and practices described herein. Accordingly, it will be understood that the invention is not to be limited to the embodiments disclosed herein, which are presented for purposes of illustration and not of limitation.

1. A method for incentivizing a user to identify a product placement within media content displayed on a primary device, the method comprising:
receiving a data record identifying the media content displayed on the primary device;
querying a database, based on the data record, for promotional data associated with the identified media content, wherein the promotional data defines a promotional opportunity to identify an object corresponding to the product placement;
transmitting the promotional data to a secondary device, wherein the secondary device displays the promotional opportunity to the user;
receiving, from the secondary device, a user input corresponding to an attempt to identify the object displayed on the primary device;
determining whether the user correctly identified the object displayed on the primary device based on the user input; and
updating a record associated with the promotional opportunity based on the determination.

2. The method of claim 1, wherein the secondary device has a touch-sensitive display screen, and wherein receiving a user input comprises receiving a user actuation of the touch-sensitive display screen at a given location.

3. The method of claim 2, wherein determining whether the user correctly identified the object displayed on the primary device comprises comparing the location of the user actuation of the touch-sensitive display screen with a known location of the object displayed on the primary device.

4. The method of claim 1 further comprising receiving a user submission of an image file and comparing the submitted image file with a stored image file that depicts the object displayed on the primary device.

5. The method of claim 1 further comprising receiving a user submission of an image file and analyzing the submitted image file to detect data indicative of the object displayed on the primary device.

6. The method of claim 1, wherein updating a record associated with the promotional opportunity comprises increasing a number of reward points stored in a user profile.

7. The method of claim 1, wherein updating a record associated with the promotional opportunity comprises modifying a video quality setting associated with video playback.

8. The method of claim 1, wherein updating a record associated with the promotional opportunity comprises modifying a setting that defines a frequency of commercial interruption during video playback.

9. The method of claim 1, wherein updating a record associated with the promotional opportunity comprises modifying a setting that defines a duration of commercials displayed during video playback.

10. The method of claim 1, wherein updating a record associated with the promotional opportunity comprises identifying media content with a playback access restriction and removing the playback access restriction.

11. A system for enabling a user to identify a product placement within media content displayed on a primary device, the system comprising:
a first database configured to store a data record identifying the media content displayed on the primary device;
a second database configured to store promotional data associated with the media content, wherein the promotional data defines a promotional opportunity to identify an object corresponding to the product placement; and
a processor configure to:
retrieve the data record identifying the media content displayed on the primary device from the first database;
query the second database, based on the data record, for the promotional data associated with the identified media content;
transmit the promotional data to a secondary device, wherein the secondary device displays the promotional opportunity to the user;
receive, from the secondary device, a user input corresponding to an attempt to identify the object displayed on the primary device;
determine whether the user correctly identified the object displayed on the primary device based on the user input; and
update a record associated with the promotional opportunity based on the determination.

12. The system of claim 11, wherein the secondary device has a touch-sensitive display screen, and wherein the processor is further configured to receive a user actuation of the touch-sensitive display screen at a given location.

13. The system of claim 12, wherein the processor is configured to compare the location of the user actuation of the touch-sensitive display screen with a known location of the object displayed on the primary device.

14. The system of claim 11, wherein the processor is further configured to receive a user submission of an image file, and wherein the processor is configured to compare the submitted image file with a stored image file that depicts the object displayed on the primary device.

15. The system of claim 11, wherein the processor is further configured to receive a user submission of an image file, and wherein the processor is configured to analyze the submitted image file to detect data indicative of the object displayed on the primary device.

16. The system of claim 11, wherein the processor is configured to update the record associated with the promotional opportunity by increasing a number of reward points stored in the record.

17. The system of claim 11, wherein the processor is configured to update the record associated with the promotional opportunity by modifying a video quality setting associated with video playback.

18. The system of claim 11, wherein the processor is configured to update the record associated with the promotional opportunity by modifying a setting that defines a frequency of commercial interruption during video playback.

19. The system of claim 11, wherein the processor is configured to update the record associated with the promotional opportunity by modifying a setting that defines a duration of commercials displayed during video playback.

20. The system of claim 11, wherein the processor is configured to update the record associated with the promotional opportunity by identifying media content with a playback access restriction and removing the playback access restriction.

21-30. (canceled)
